(19) United States
(12) Patent Application Publication
(10) Pub. No.: US 2019/0362058 A1
(43) Pub. Date: Nov. 28, 2019

(54) FACE UNLOCKING METHOD AND DEVICE, ELECTRONIC DEVICE, AND COMPUTER STORAGE MEDIUM

(71) Applicant: BEIJING KUANGSHI TECHNOLOGY CO., LTD., Beijing (CN)

(72) Inventor: Yu Liu, Beijing (CN)

(21) Appl. No.: 16/212,334

(22) Filed: Dec. 6, 2018

(30) Foreign Application Priority Data
May 24, 2018 (CN) 201810510589.8

(51) Int. Cl. G06F 21/32; G06K 9/00; G06K 9/62; G06F 16/532

(52) U.S. Cl. CPC G06F 21/32; G06K 9/00268; G06F 16/532; G06K 9/00624; G06K 9/6215; G06K 9/00288

(57) ABSTRACT

A face unlocking method and device, an electronic device and a computer storage medium are disclosed. The face unlocking method includes: acquiring real-time image information of a user for unlocking, and generating a real-time facial image of the user for unlocking; extracting a feature based on the real-time facial image of the user for unlocking, and generating a real-time facial feature of the user for unlocking; performing search and comparison on the real-time facial feature in a face database to obtain an identity recognition result, and determining whether to perform scene recognition according to the identity recognition result; in a case where the scene recognition is performed, performing the scene recognition on the real-time image information to obtain a scene recognition result, and determining whether to unlock according to the scene recognition result; and in a case where the scene recognition is not performed, not performing unlocking.

### CROSS-REFERENCE TO RELATED APPLICATIONS

The application claims priority to the Chinese Patent Application No. 201810510589.8, filed on May 24, 2018, the entire disclosure of which is incorporated herein by reference as part of the present application.

### TECHNICAL FIELD

Embodiments of the present disclosure relate to a face unlocking method and device, an electronic device, and a computer storage medium.

### BACKGROUND

Modes for unlocking intelligent terminal devices usually include following types: the first type, unlocking by means of a digital password; the second type, unlocking by means of a fingerprint, that is, the fingerprint of a user is pre-stored in the intelligent terminal device, and when the user unlocks with the fingerprint, the intelligent terminal device may be unlocked in a case where the fingerprint of the user matches the fingerprint stored in the intelligent terminal device; the third type, unlocking by means of sliding a touch screen; the fourth type, unlocking by means of a gesture, that is, the intelligent terminal device may be unlocked when a gesture of the user matches a gesture pre-stored in the intelligent terminal device. The unlocked intelligent terminal device may be a mobile phone, a tablet computer, or other intelligent terminal.

### SUMMARY

At least one embodiment of the present disclosure provides a face unlocking method, comprising: acquiring real-time image information of a user for unlocking, and generating a real-time facial image of the user for unlocking; extracting a feature based on the real-time facial image of the user for unlocking, and generating a real-time facial feature of the user for unlocking; performing search and comparison on the real-time facial feature in a face database to obtain an identity recognition result, and determining whether to perform scene recognition according to the identity recognition result; in a case where the scene recognition is performed, performing the scene recognition on the real-time image information to obtain a scene recognition result, and determining whether to unlock according to the scene recognition result; and in a case where the scene recognition is not performed, not performing unlocking.

At least one embodiment of the present disclosure further provides a face unlocking device, comprising: an image acquisition module, configured to acquire image information of an authorized user or real-time image information of a user for unlocking, and perform a face detection on the image information of the authorized user or the real-time image information of the user for unlocking, to generate a facial image of the authorized user or a real-time facial image of the user for unlocking; a facial feature extraction module, configured to extract a facial feature based on the facial image of the authorized user or the real-time facial image of the user for unlocking, to obtain a facial image feature of the authorized user or a real-time facial feature of the user for unlocking; a storage medium module, configured to store the facial image feature of the authorized user in a face database; a face comparison module, configured to perform search and comparison on the real-time facial feature in the face database to obtain an identity recognition result, and determine whether to perform scene recognition according to the identity recognition result; a scene recognition module, configured to recognize a scene in the real-time image information to obtain a scene recognition result; and a physical lock control module, configured to control a lock state of a physical device according to the identity recognition result or the scene recognition result.

At least one embodiment of the present disclosure further provides an electronic device, comprising a memory, a processor, and a computer program stored on the memory and executed by the processor, wherein the processor executes the computer program to implement the face unlocking method described above.

At least one embodiment of the present disclosure further provides a computer storage medium, storing with a computer program, wherein the computer program is executed by a computer to implement the face unlocking method described above.

### BRIEF DESCRIPTION OF THE DRAWINGS

By describing embodiments of the present disclosure in more detail with reference to the drawings, the above and other objectives, features and advantages of the present disclosure become more obvious. The drawings are provided for further understanding the embodiments of the present disclosure and constitute a part of the specification, and are used for explaining the present disclosure together with the embodiments of the present disclosure rather than limiting the present disclosure. In the drawings, same reference symbols usually denote same components or steps.

FIG. 1 is a schematic block diagram of an electronic device according to some embodiments of the present disclosure;

FIG. 2 is a schematic flow chart of a face unlocking method according to some embodiments of the present disclosure;

FIG. 3 is a schematic block diagram of a face unlocking device according to some embodiments of the present disclosure; and

FIG. 4 is a schematic block diagram of an electronic device according to some embodiments of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, “coupled”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

Facial biometric feature information of users is not used in traditional unlocking methods, so any person may unlock an intelligent terminal device when performing an unlocking mode on the intelligent terminal device, which may adversely affect security of the intelligent terminal device. Therefore, traditional unlocking methods are not safe, and there is a possibility of information leakage.

Face unlocking is a means of authority administration using a face recognition or face verification technology, and a terminal system may take face, which is a biometric feature, as a password for authority protection. Face unlocking is applied in many fields such as unlocking a smart mobile phone, unlocking an access of a bank or a prison, and the like. However, in an ordinary face unlocking technology, only unlocking is performed, without scene recognition. When a person for unlocking is in an involuntary state (for example, being held under duress), unlocking may still be performed successfully, so as to cause loss to the person for unlocking, and result in low security.

The present disclosure is proposed in consideration of the above-described problems. Embodiments of the present disclosure provide a face unlocking method and device, an electronic device and a computer storage medium, in which an extracted feature of a facial image in an acquired image is recognized, and scene recognition is performed according to a recognition result to distinguish whether a user for unlocking performs unlocking voluntarily, so as to avoid loss caused by involuntary unlocking, and an alarm may be given without being perceived, which effectively protects personal safety of the person for unlocking, and improves security of face unlocking.

Hereinafter, the embodiments of the present disclosure will be described in detail with reference to the accompanying drawings. It should be noted that, same reference symbols in different drawings are used for denoting same elements that have been described.

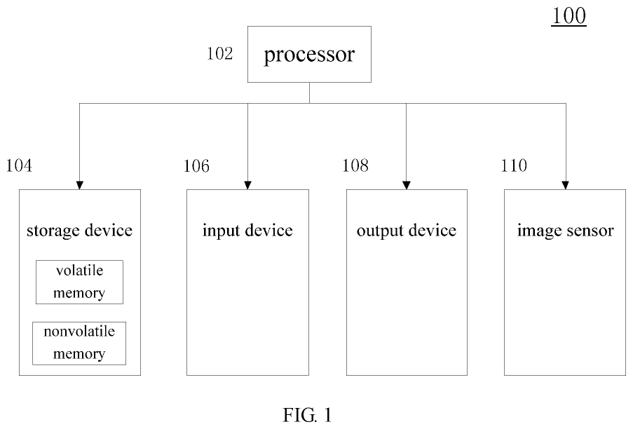

Firstly, an electronic device 100 according to some embodiments of the present disclosure is described with reference to FIG. 1. The electronic device 100 can be used to implement the face unlocking method of some embodiments of the present disclosure.

As illustrated in FIG. 1, the electronic device 100 comprises one or more processors 102, one or more storage devices 104, an input device 106, an output device 108 and an image sensor 110, and these components are interconnected through a bus system and/or a connecting mechanism of other form (not illustrated in the figure). It should be noted that, the components and the structures of the electronic device 100 illustrated in FIG. 1 are merely exemplary and not limitative, and the electronic device 100 may have other components and structures according to needs.

The processor 102 may be a central processing unit (CPU), a graphics processing unit (GPU), or a processing unit of other form with a data processing capability and/or an instruction execution capability, and may control other components in the electronic device 100 to execute a desired function.

The storage device 104 may include one or more computer program products, and the computer program product may include computer readable storage media of various forms, for example, a volatile memory and/or a nonvolatile memory. The volatile memory may include, for example, a random access memory (RAM) and/or a cache, and the like. The nonvolatile memory may include, for example, a read only memory (ROM), a hard disk, a flash memory, and the like. One or more computer program instructions may be stored in the computer readable storage medium, and the processor 102 may run the program instructions, to implement a client side function (implemented by the processor 102) according to the embodiments of the present disclosure described hereinafter and/or other desired functions. Various application programs and various data, for example, various data used and/or generated by the application programs, etc., may also be stored in the computer readable storage medium.

For example, the storage device 104 may further include a memory remote from the processor 102, for example, a network attachment memory accessed via a communication network (not illustrated in the figure). The communication network may be the Internet, one or more internal networks, a local area network (LAN), a wide area network (WAN) or a storage area network (SAN), and the like, or a combination of various communication networks. In this way, access to the storage device 104 may be controlled by a memory controller (not illustrated in this figure). For example, the communication network may be in a wireless communication mode or a wired communication mode. The wireless communication mode may adopt any wireless communication protocol, for example, Bluetooth, ZigBee, global system for mobile communications (GSM), wideband code division multiple access (W-CDMA), code division multiple access (CDMA), time division multiple access (TDMA), wireless fidelity (Wi-Fi), and the like, which is not limited in the embodiments of the present disclosure.

The input device 106 may be a device used by a user for inputting an instruction and may include one or more of a keyboard, a mouse, a microphone, a touch screen, and the like.

The output device 108 may output various information (e.g., an image or a sound) to the outside (e.g., a user), and may include one or more of a display, a speaker, and the like.

The image sensor 110 may shoot an image (e.g., a photo, a video, etc.) desired by a user, and store the shot image in the storage device 104 for usage by other components.

Exemplarily, the electronic device 100 may be implemented as a smart mobile phone, a tablet computer, a video acquisition terminal of an access control system, or the like, may also be implemented as a laptop, an E-book, a recreational machine, a television, a digital photo frame, a navigator, and any other device, and may also be a combination of any electronic devices and hardware, which is not limited in the embodiments of the present disclosure. The electronic device 100 may have more or fewer components than that as illustrated in FIG. 1, or have different component configurations. Each component may be implemented by hardware, software, or a combination of hardware and software, and may include one or more signal processors and/or application specific integrated circuits. The electronic device 100 may implement the face unlocking method provided by the embodiments of the present disclosure by executing computer programs by the processor 102, so as to perform unlocking utilizing the face unlocking method provided by the embodiments of the present disclosure, which may improve security of face unlocking.

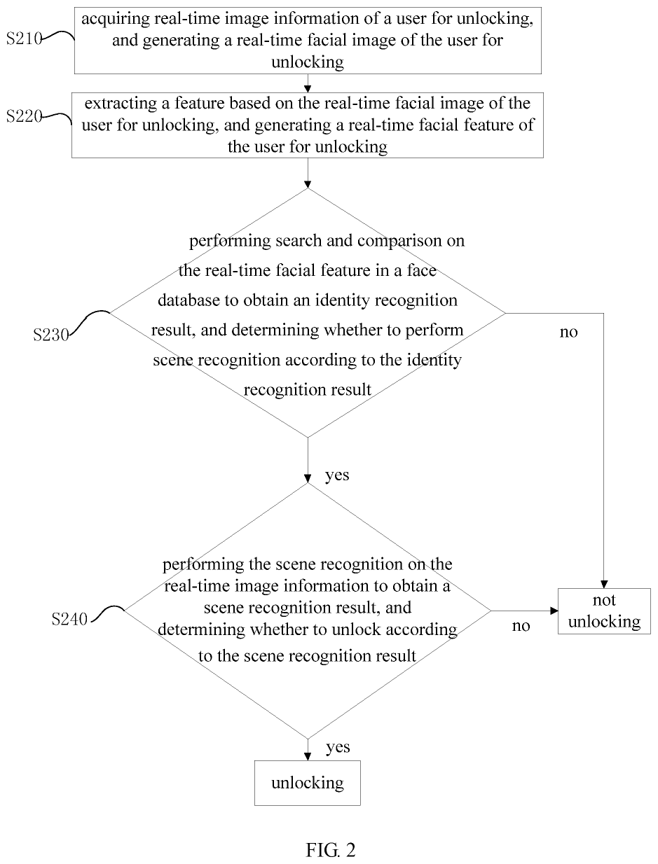

Hereinafter, a face unlocking method 200 according to some embodiments of the present disclosure is described with reference to FIG. 2. For example, the face unlocking method 200 is used in an electronic device. For example, in an example, the face unlocking method 200 comprises steps S210, S220, S230 and S240 below.

Firstly, in step S210: acquiring real-time image information of a user for unlocking, and generating a real-time facial image of the user for unlocking;

In step S220: extracting a feature based on the real-time facial image of the user for unlocking, and generating a real-time facial feature of the user for unlocking;

In step S230: performing search and comparison on the real-time facial feature in a face database to obtain an identity recognition result, and determining whether to perform scene recognition according to the identity recognition result; and

In step S240: in a case where the scene recognition is performed, performing the scene recognition on the real-time image information to obtain a scene recognition result, and determining whether to unlock according to the scene recognition result; and in a case where the scene recognition is not performed, not performing unlocking.

Exemplarily, the face unlocking method 200 according to the embodiment of the present disclosure may be implemented in a device, an apparatus or a system having a memory and a processor.

The face unlocking method 200 according to the embodiment of the present disclosure may be arranged at a facial image acquisition terminal, for example, in a field of security application, may be arranged at an image acquisition terminal of an access control system; and in a field of financial application, may be arranged at a personal terminal, such as a smart mobile phone, a tablet computer, a personal computer, or the like.

Exemplarily, the face unlocking method 200 according to the embodiment of the present disclosure may further be arranged at a server side (or a cloud side) and a personal terminal in a distribution way. For example, in the field of financial application, the acquired real-time image is transmitted to the server side (or the cloud side), the real-time facial image may be generated on the server side (or the cloud side), the generated real-time facial image is transmitted by the server side (or the cloud side) to the personal terminal, and the personal terminal performs face unlocking according to the received real-time facial image. For another example, the real-time facial image may be generated on the server side (or the cloud side), the personal terminal transmits video information acquired by an image sensor and image information acquired by a non-image sensor to the server side (or the cloud side), and then the server side (or the cloud side) performs face unlocking.

In the face unlocking method 200 according to the embodiment of the present disclosure, the extracted feature of the facial image in the acquired image is recognized, and scene recognition is performed according to the recognition result to distinguish whether the user for unlocking performs unlocking voluntarily, so as to avoid loss caused by involuntary unlocking, and an alarm may be given without being perceived, which effectively protects personal safety of the person for unlocking, and improves security of face unlocking.

Exemplarily, according to the embodiment of the present disclosure, the face unlocking method 200, before executing step S210, further comprises: acquiring image information of all authorized users, and establishing the face database based on the image information of the authorized users.

Exemplarily, establishing the face database includes: acquiring the image information of the authorized user including a face of the authorized user, pre-processing the image information of the authorized user, generating a corresponding facial image of the authorized user, extracting a feature based on the facial image of the authorized user to obtain a facial feature of the authorized user, and storing the facial image of the authorized user and the corresponding facial feature of the authorized user in the face database, or storing the facial feature of the authorized user in the face database.

Exemplarily, the face database may be established respectively according to a single authorized user or a plurality of authorized users, and in a case of a plurality of authorized users, each user has a separate facial image feature database corresponding to his/her own authority. For example, the facial image of the authorized user and the corresponding facial feature of the authorized user in the face database are called as a face base graph.

Exemplarily, the image information of the authorized user includes a single-frame image, continuous multi-frame images, or discontinuous arbitrarily selected multi-frame images.

Exemplarily, the facial image of the authorized user is an image frame including the face of the authorized user determined by performing face detection and face tracking processing on the image information of the authorized user. For example, a size and a position of the face of the authorized user may be determined in a start image frame including the face of the authorized user by using various face detection methods commonly used in the art, for example, template matching, support vector machine (SVM), neural network, and the like. Then the face of the authorized user is tracked based on color information, a local feature, or motion information of the face of the authorized user, so as to determine respective frames of image including the face of the authorized user in the video. The above-described processing of determining the image frame including the face of the authorized user by face detection and face tracking is common processing in the field of image processing, which is not be described in detail herein.

According to the embodiment of the present disclosure, step S210 may further include: acquiring the real-time image information of the user for unlocking, determining whether or not the real-time image information comprises face information after pre-processed, and in a case where yes, generating the corresponding real-time facial image of the user for unlocking, otherwise, continuing to acquire the real-time image information of the user for unlocking.

Exemplarily, the real-time facial image of the user for unlocking is an image frame including the face of the user for unlocking determined by performing face detection and face tracking processing on the real-time image information of the user for unlocking. The processing of determining the image frame including the face of the user for unlocking by face detection and face tracking is common processing in the field of image processing, and may also be referred to the above description of the image frame including the face of the authorized user, which is not be described in detail herein.

According to the embodiment of the present disclosure, step S220 may further include: reducing a dimension of the real-time facial feature after the real-time facial feature is generated, and performing the search and comparison on the real-time facial feature whose dimension is reduced in the face database, to speed up the search and comparison.

Exemplarily, feature extraction may be performed by using various suitable facial feature extraction methods, such as local binary pattern (LBP), histogram of oriented gradients (HoG), principal component analysis (PCA), neural network, and the like, to generate a plurality of feature vectors. Optionally, with respect to the face in each frame image of a facial image sequence, the feature vectors are generated by using a same feature extraction method. Hereinafter, only for integrity of the description, the facial feature extraction method used in this embodiment is described briefly.

In some embodiments, a feature extraction method based on a convolutional neural network is used for extracting a feature of a face in a facial image sequence in a video to generate a plurality of feature vectors respectively corresponding to the face in the facial image sequence. For example, firstly, with respect to each frame image in the facial image sequence, a facial image region corresponding to the face is determined; and subsequently, feature extraction is performed on the facial image region based on the convolutional neural network, to generate a feature vector corresponding to the face in the frame image. Here, the facial image region may be subjected to the feature extraction as a whole, or different sub-image regions of the facial image region may be respectively subjected to the feature extraction.

According to the embodiment of the present disclosure, step S230 may further include: performing the search and comparison on the real-time facial feature of the user for unlocking in the face database, to obtain a search result; and obtaining the identity recognition result according to the search result and a recognition threshold.

Exemplarily, the search result refers to a result with a highest similarity score obtained by performing the search and comparison on the real-time facial feature in the face database.

Exemplarily, the search result refers to a face ID of a face base graph with highest similarity, when the search and comparison is performed on the real-time facial feature of the user for unlocking in the face database. In some embodiments, the search result and the face base graph may be represented by the ID, and for example, a digital code 0123 represents a face base graph having a face ID of 0123 in a face database including 10,000 face base graphs. When a facial feature to be recognized is searched in the face database, the search result is returned, which may be a corresponding face ID number.

Step S230 may further include: in a case where a similarity score of the search result obtained by searching in the face database is less than the recognition threshold, obtaining the identity recognition result as none; and in a case where the similarity score is greater than or equal to the recognition threshold, obtaining the identity recognition result as the search result. In some embodiments, when a full score is 100 points, the recognition threshold is, for example, 90 points. Of course, the recognition threshold may also be other scores, which is not limited in the embodiments of the present disclosure.

Step S230 may further include: in a case where the identity recognition result is none, not performing the scene recognition; and in a case where the identity recognition result is the search result, performing the scene recognition.

According to the embodiment of the present disclosure, step S240 may further include: extracting a scene image feature according to the real-time image information, and inputting a pre-trained model, to obtain the scene recognition result to indicate safety or danger.

In some embodiments, training the above-described pre-trained model includes:

Firstly, performing operations such as cropping and zooming out on a group of scene images (already labeled as dangerous or safe) of known category, and normalizing the scene images of known category to change them to images of a size s*s. Specific operations are as follows:

(1) Zooming out the scene image of known category: reducing a size N in the scene image of known category to s in proportion; reducing M to m in a proportion of N/s (m>s); then cropping the reduced m side to remove portions more than s on both sides; and adding a scene label (danger or safety) to the scene image of a size s*s obtained by processing, so as to establish a whole scene image dataset.

(2) Cropping a portion of the scene image of known category with a sliding window of s*s from left to right (or from top to bottom), with a sliding step of s, and with respect to a portion which is less than s where the window slides finally, aligning the window with an edge of the image, extending to the inside of the image to complement the insufficient portion, and establishing a local scene image dataset with the image cropped by each window.

Then, influence of brightness of the scene images in the whole scene image dataset and the local scene image dataset is removed, and de-mean value processing is performed on the images in the whole scene image dataset and the local scene image dataset.

Next, a scale-invariant feature transform (SIFT) feature of the scene image in the local scene image dataset is extracted, a SIFT feature center is clustered and generated, to obtain a feature dictionary, a histogram vector of the scene image on the feature dictionary is calculated, and the feature vector plus label data is taken as a sample data training classifier, to obtain a feature word bag classification model of the scene.

Then, a convolution layer feature and a pooling layer feature of the scene image in the whole scene image dataset are extracted, and classifier training and testing is performed on these features through a fully connected layer, to obtain a deep convolutional neural network classification model.

Finally, outputs with a length of n (e.g., a scene category is set to n) is obtained from the scene image of known category through the feature word bag classification model and the deep neural network model respectively, the two outputs are combined into a vector of 2n as sample data, and then a three-layer neural network model is trained as the above-described pre-trained model.

According to the embodiment of the present disclosure, while unlocking determination is made, whether or not the user for unlocking is in a voluntary state may be distinguished through the scene recognition.

According to the embodiment of the present disclosure, step S240 may further include: in a case where the scene recognition result indicates safety, performing unlocking; and in a case where the scene recognition result indicates danger, performing alarming and/or not performing unlocking.

Step S240 may further include: in a case where the scene recognition result indicates safety, performing unlocking and not performing alarming; and in a case where the scene recognition result indicates danger, not performing unlocking and performing alarming.

Exemplarily, the above-described alarming includes: sending alarm information, in which the alarm information comprises at least one of the scene recognition result, the real-time image information, or location information; or triggering an alarm bell. Further, the alarm information is sent to an alarm platform and/or a pre-assigned contact person, to assist relevant personnel to handle in time. In some embodiments, the above-described alarming may not be perceived by the user for unlocking, that is, the alarming is performing without being perceived, so as to effectively protect personal safety of the person for unlocking and improve security of face unlocking.

Exemplarily, the scene recognition result further indicates dangerous scene information, and the dangerous scene information includes at least one of presence of a threatening appliance, an amount of threateners or attribute information of threatener. The attribute information of threatener includes age range, clothing, head type, facial feature, gender, and other typical feature of the threatener.

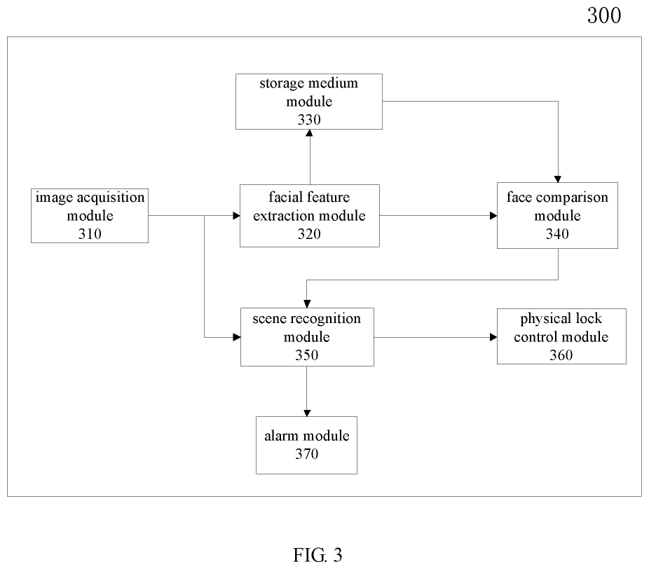

FIG. 3 is a schematic block diagram of a face unlocking device 300 according to some embodiments of the present disclosure.

As illustrated in FIG. 3, the face unlocking device 300 according to the embodiment of the present disclosure comprises an image acquisition module 310, a facial feature extraction module 320, a storage medium module 330, a face comparison module 340, a scene recognition module 350 and a physical lock control module 360.

Exemplarily, the face unlocking device 300 further comprises an alarm module 370.

The image acquisition module 310 is configured to acquire image information of an authorized user or real-time image information of a user for unlocking, and perform a face detection on the image information of the authorized user or the real-time image information of the user for unlocking, to generate a facial image of the authorized user or a real-time facial image of the user for unlocking.

The facial feature extraction module 320 is configured to extract a facial feature based on the facial image of the authorized user or the real-time facial image of the user for unlocking, to obtain a facial image feature of the authorized user or a real-time facial feature of the user for unlocking.

The storage medium module 330 is configured to store the facial image feature of the authorized user in a face database.

The face comparison module 340 is configured to perform search and comparison on the real-time facial feature in the face database to obtain an identity recognition result, and determine whether to perform scene recognition according to the identity recognition result.

The scene recognition module 350 is configured to recognize a scene in the real-time image of the user for unlocking to obtain a scene recognition result.

The physical lock control module 360 is configured to control a lock state of a physical device according to the identity recognition result or the scene recognition result.

The alarm module 370 is configured to perform alarming according to the scene recognition result.

The face unlocking device 300 according to the embodiment of the present disclosure recognizes the extracted feature of the facial image in the acquired image, and performs the scene recognition according to the recognition result to distinguish whether the user for unlocking performs unlocking voluntarily, so as to avoid loss caused by involuntary unlocking, and an alarm may be given without being perceived, which effectively protects personal safety of the person for unlocking, and improves security of face unlocking.

According to the embodiment of the present disclosure, the image acquisition module 310 may further include:

an image information receiving module, configured to receive the image information including the authorized user or the real-time image information of the user for unlocking;

a framing module, configured to perform video image framing on video data in the image information of the authorized user or the real-time image information of the user for unlocking;

a face detection module, configured to perform face detection and tracking on a single-frame image output by the image information receiving module or each frame of multi-frame images output by the framing module, and generate the facial image of the authorized user or the real-time facial image of the user for unlocking; and

an obtaining determination module, configured to determine whether or not the real-time image information of the user for unlocking comprises face information, and in a case where yes, the face detection module generates the corresponding real-time facial image of the user for unlocking, otherwise, continue to acquire the real-time image information of the user for unlocking.

Exemplarily, the facial image of the authorized user or the real-time facial image of the user for unlocking is an image frame including the face of the authorized user or the user for unlocking determined by the face detection module through performing face detection and face tracking processing on the single-frame image output by the image information receiving module or each frame image output by the framing module. For example, the face detection module may determine a size and a position of the face in a start image frame including the face by using various face detection methods commonly used in the art, for example, template matching, support vector machine (SVM), neural network, and the like. Then the face is tracked based on color information, a local feature, or motion information of the face, so as to determine each frame of images including the face in the video. The above-described processing of determining the image frame including the face by using face detection and face tracking is common processing in the field of image processing, which is not described in detail herein.

Exemplarily, the image information of the authorized user includes a single-frame image, continuous multi-frame images or discontinuous arbitrarily selected multi-frame images.

According to the embodiment of the present disclosure, the facial feature extraction module 320 may further include: a facial feature dimension reduction module, configured to reduce a dimension of the real-time facial feature of the user for unlocking after the real-time facial feature of the user for unlocking is generated.

Exemplarily, the facial feature extraction module 320 may perform feature extraction by using various suitable facial feature extraction methods, such as local binary pattern (LBP), histogram of oriented gradients (HoG), principal component analysis (PCA), neural network, and the like, to generate a plurality of feature vectors. Optionally, with respect to the face in the facial image of the authorized user or the real-time facial image of the user for unlocking, the feature vectors are generated by using a same feature extraction method. Hereinafter, only for integrity of the description, a working principle of the facial feature extraction module 320 used in this embodiment is briefly described below.

In some embodiments, the facial feature extraction module 320 performs feature extraction on the face in the facial image of the authorized user or the real-time facial image of the user for unlocking by using a feature extraction method based on a convolutional neural network to generate a plurality of corresponding feature vectors. For example, firstly, with respect to the facial image of the authorized user or the real-time facial image of the user for unlocking, a facial image region corresponding to the face of the authorized user or the user for unlocking is determined; and subsequently, feature extraction is performed on the facial image region based on the convolutional neural network, to generate a feature vector corresponding to the face in the frame image. Here, the facial image region may be subjected to feature extraction as a whole, or different sub-image regions of the facial image region may be subjected to feature extraction respectively.

According to the embodiment of the present disclosure, the storage medium module 330 may be further configured to store the facial image of the authorized user in the face database.

Exemplarily, the face database may be established respectively according to a single authorized user or a plurality of authorized users; and in a case of a plurality of authorized users, each user has a separate facial image feature database corresponding to his/her own authority.

According to the embodiment of the present disclosure, the face comparison module 340 may further include:

a face search module, configured to perform the search and comparison on the real-time facial feature of the user for unlocking in the face database, to obtain a search result;

an identity recognition module, configured to obtain an identity recognition result according to the search result and a recognition threshold; and

a scene recognition determination module, configured to determine whether to perform the scene recognition according to the identity recognition result.

Exemplarily, the search result refers to a result with a highest similarity score obtained by performing the search and comparison on the real-time facial feature in the face database.

Exemplarily, the search result refers to a face ID of a face base graph with the highest similarity score, when the search and comparison is performed on the real-time facial feature of the user for unlocking in the face database. In some embodiments, the search result and the face base graph may be represented with an ID, and for example, a digital code 0123 represents a base graph having a face ID of 0123 in a face database including 10,000 face base graphs. When a facial feature to be recognized is searched in the face database, the search result is returned, which may be a corresponding face ID number.

Exemplarily, the identity recognition module is further configured to: obtain the identity recognition result as none, in a case where a similarity score of the search result obtained by searching in the face database is less than the recognition threshold; and obtain the identity recognition result as the search result, in a case where the similarity score is greater than or equal to the recognition threshold. In some embodiments, when a full score is 100 points, the recognition threshold is, for example, 90 points. Of course, the recognition threshold may also be other scores, which is not limited in the embodiments of the present disclosure.

Exemplarily, the scene recognition determination module is further configured to: not perform the scene recognition, in a case where the identity recognition result is none; and perform the scene recognition, in a case where the identity recognition result is the search result.

According to the embodiment of the present disclosure, the scene recognition module 350 may further include:

an image pre-processing module, configured to pre-process the real-time image information of the user for unlocking;

a scene image feature extraction module, configured to extract a scene image feature from the pre-processed real-time image information of the user for unlocking; and

a scene recognition module, including a pre-trained model, configured to input the scene image feature into the pre-trained model, to obtain the scene recognition result to indicate safety or danger.

In some embodiments, training the above-described pre-trained model includes:

Firstly, performing operations such as cropping and zooming out on a group of scene images (already labeled as dangerous or safe) of known category, and normalizing the scene images of known category to change them to images of a size s*s. Specific operations are as follows:

(1) Zooming out the scene image of known category: reducing a size N in the scene image of known category to s in proportion; reducing M to m in a proportion of N/s (m>s); then cropping the reduced m side to remove portions more than s on both sides; and adding a scene label (danger or safety) to the scene image of a size s*s obtained by processing, so as to establish a whole scene image dataset.

(2) Cropping a portion of the scene image of known category with a sliding window of s*s from left to right (or from top to bottom), with a sliding step of s, and with respect to a portion which is less than s where the window slides finally, aligning the window with an edge of the image, extending to the inside of the image to complement the insufficient portion, and establishing a local scene image dataset with the image cropped by each window.

Then, influence of brightness of the scene images in the whole scene image dataset and the local scene image dataset is removed, and de-mean value processing is performed on the images in the whole scene image dataset and the local scene image dataset.

Next, a scale-invariant feature transform (SIFT) feature of the scene image in the local scene image dataset is extracted, a SIFT feature center is clustered and generated, to obtain a feature dictionary, a histogram vector of the scene image on the feature dictionary is calculated, and the feature vector plus label data is taken as a sample data training classifier, to obtain a feature word bag classification model of the scene.

Then, a convolution layer feature and a pooling layer feature of the scene image in the whole scene image dataset are extracted, and classifier training and testing is performed on these features through a fully connected layer, to obtain a deep convolutional neural network classification model.

Finally, outputs with a length of n (e.g., a scene category is set to n) is obtained from the scene image of known category through the feature word bag classification model and the deep neural network model respectively, the two outputs are combined into a vector of 2n as sample data, and then a three-layer neural network model is trained as the above-described pre-trained model.

The scene recognition module 350 according to the embodiment of the present disclosure may distinguish whether or not the user for unlocking is in a voluntary state by the scene recognition, while making unlocking determination.

According to the embodiment of the present disclosure, the physical lock control module 360 may be further configured to: control the physical device to be in a locked state, when the identity recognition result is none, or when the identity recognition result is the search result and the scene recognition result indicates danger; or control the physical device to be an unlocked state, when the identity recognition result is the search result and the scene recognition result indicates safety.

According to the embodiment of the present disclosure, the alarm module 370 may be further configured to: perform unlocking in a case where the scene recognition result indicates safety; and perform alarming and/or not perform unlocking in a case where the scene recognition result indicates danger.

The alarm module 370 may be further configured to: perform unlocking and not perform alarming in a case where the scene recognition result indicates safety; not perform unlocking and perform alarming in a case where the scene recognition result indicates danger.

Exemplarily, the above-described alarming includes: sending alarm information, in which the alarm information comprises at least one of the scene recognition result, the real-time image information, or location information; or triggering an alarm bell. Further, the alarm information is sent to an alarm platform and/or a pre-assigned contact person, to assist relevant personnel to handle in time. In some embodiments, the above-described alarming may not be perceived by the user for unlocking, that is, the alarming is performed without being perceived, so as to effectively protect personal safety of the person for unlocking and improve security of face unlocking.

Exemplarily, the scene recognition result further indicates dangerous scene information, and the dangerous scene information includes at least one of presence of a threatening appliance, an amount of threateners or attribute information of threatener. For example, the attribute information of threatener includes age range, clothing, head type, facial feature, gender, and other typical feature of the threatener.

The image acquisition module 310, the facial feature extraction module 320, the storage medium module 330, the face comparison module 340, the scene recognition module 350, the physical lock control module 360, the alarm module 370, and other modules may all be implemented by a processor executing program instructions stored in a storage device, and may also be implemented by special-purpose or general-purpose electronic hardware (or circuits), which is not limited in the embodiments of the present disclosure. Specific configuration of the above-described electronic hardware is not limited and may include an analog device, a digital chip or other applicable device. Implementation mode of each module may be the same or different.

Those ordinarily skilled in the art may be aware that, the modules, the units and the algorithm steps of the examples described in the embodiments of the present disclosure may be implemented by electronic hardware or a combination of computer software and electronic hardware. Whether these functions are executed by hardware or software depends on specific application and design constraints of the technical solution. Those ordinarily skilled in the art may implement the described functions by using different methods according to each particular application, but such implementation should not be considered to be beyond the scope of the present disclosure.

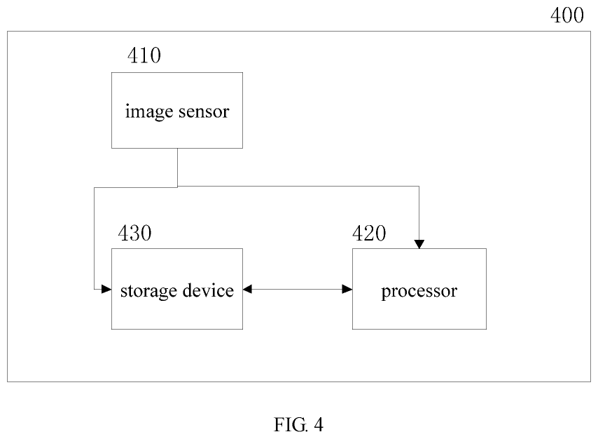

FIG. 4 is a schematic block diagram of an electronic device 400 according to some embodiments of the present disclosure. The electronic device 400 comprises an image sensor 410, a storage device 430 and a processor 420.

The image sensor 410 is configured to acquire image information.

The storage device 430 stores a program code (i.e., a computer program) for implementing the corresponding steps in the face unlocking method (for example, the above-described face unlocking method 200) according to the embodiment of the present disclosure.

The processor 420 is configured to execute the program code stored in the storage device 430, so as to implement the corresponding steps of the face unlocking method according to the embodiment of the present disclosure, and to implement the image acquisition module 310, the facial feature extraction module 320, the storage medium module 330, the face comparison module 340, the scene recognition module 350, the physical lock control module 360 and the alarm module 370 in the face unlocking device (for example, the above-described face unlocking device 300) according to the embodiment of the present disclosure.

In some embodiments, when the above-described program code is executed by the processor 420, steps below are implemented:

acquiring real-time image information of a user for unlocking, and generating a real-time facial image of the user for unlocking;

extracting a feature based on the real-time facial image of the user for unlocking, and generating a real-time facial feature of the user for unlocking;

performing search and comparison on the real-time facial feature in a face database to obtain an identity recognition result, and determining whether to perform scene recognition according to the identity recognition result; and

in a case where the scene recognition is performed, performing the scene recognition on the real-time image information to obtain a scene recognition result, and determining whether to unlock according to the scene recognition result; and

in a case where the scene recognition is not performed, not performing unlocking.

In addition, when the above-described program code is executed by the processor 420, steps below are further implemented.

Exemplarily, the scene recognition includes: extracting a scene image feature according to the real-time image information, and inputting a pre-trained model, to obtain the scene recognition result to indicate safety or danger.

Exemplarily, determining whether to unlock includes: in a case where the scene recognition result indicates safety, performing unlocking; and in a case where the scene recognition result indicates danger, performing alarming and/or not performing unlocking.

Exemplarily, the alarming includes: sending alarm information, in which the alarm information includes at least one of the scene recognition result, the real-time image information, or location information; or triggering an alarm bell.

Exemplarily, the scene recognition result further indicates dangerous scene information, and the dangerous scene information includes at least one of presence of a threatening appliance, an amount of threateners or attribute information of threatener.

Exemplarily, obtaining the identity recognition result includes: performing the search and comparison on the real-time facial feature in the face database, to obtain a search result; obtaining the identity recognition result according to the search result and a recognition threshold; and the search result refers to a result with a highest similarity score obtained by performing the search and comparison on the real-time facial feature in the face database.

Exemplarily, obtaining the identity recognition result according to the search result and the recognition threshold includes: in a case where a similarity score of the search result obtained by searching in the face database is less than the recognition threshold, obtaining the identity recognition result as none; and in a case where the similarity score is greater than or equal to the recognition threshold, obtaining the identity recognition result as the search result.

Exemplarily, determining whether to perform the scene recognition includes: in a case where the identity recognition result is none, not performing the scene recognition; and in a case where the identity recognition result is the search result, performing the scene recognition.

Exemplarily, after the real-time facial feature is generated, a dimension of the real-time facial feature may be reduced, and the search and comparison is performed on the real-time facial feature whose dimension is reduced in the face database.

Exemplarily, when the above-described program code is executed by the processor 420, the face unlocking method implemented further comprises: acquiring image information of all authorized users, and establishing the face database based on the image information of the authorized users.

Exemplarily, acquiring the real-time image information of the user for unlocking and generating the real-time facial image of the user for unlocking further includes: acquiring the real-time image information of the user for unlocking, determining whether or not the real-time image information comprises face information after pre-processed; and in a case where yes, generating the corresponding real-time facial image of the user for unlocking, otherwise, continuing to acquire the real-time image information of the user for unlocking.

Exemplarily, establishing the face database includes: acquiring the image information of the authorized user including a face of the authorized user, pre-processing the image information of the authorized user, generating a corresponding facial image of the authorized user, extracting a feature based on the facial image of the authorized user to obtain a facial feature of the authorized user, and storing the facial feature of the authorized user in the face database.

Exemplarily, the electronic device 400 (e.g., the storage device 430 in the electronic device 400) may further be configured to store image data acquired by the image sensor 410, which include video data and non-video data.

Exemplarily, storage modes of the above-described video data may include one of the following storage modes: local storage, database storage, hadoop distributed file system (hdfs) storage and remote storage, and a storage service address may include a server IP and a server port. For example, the local storage refers to that the video data received by the electronic device 400 is stored locally in the system; the database storage refers to that the video data received by the electronic device 400 is stored in a database of the system, and the database storage requires a corresponding database to be installed on the electronic device 400; the hadoop distributed file system storage refers to that the video data received by the electronic device 400 is stored in a hadoop distributed file system, and the hadoop distributed file system storage requires a hadoop distributed file system to be installed on the electronic device 400; and the remote storage refers to that the video data received by the electronic device 400 is transferred to other storage service for storage. In other examples, the configured storage mode may further include a storage mode of any suitable type, which is not limited in the present disclosure.

Exemplarily, when the video data is accessed as described above, it may be performed in a form of a stream. For example, access to the video data may be implemented in a binary stream transmission mode. After the electronic device 400 sends a file in the form of a stream, when the storage service obtains the file stream, the storage service starts to save the file. Unlike the mode of reading into memory, interactive access at both terminals is proceed fast in the form of a stream, without waiting for either party to read the file into memory and then send the next file. Similarly, the electronic device 400 acquires the file from the storage service also in such a mode. The storage service transfers the file to the electronic device 400 in the form of a stream, without reading into memory and then sending. When the file stream is not transferred completely and the two terminals are disconnected, services of both parties trigger an exception, and the service performs capturing. At this time, reacquiring or storing the file may be tried again after waiting for some time, for example, a few seconds. Efficient and fast file access may be implemented in the form of a stream.

In addition, some embodiments of the present disclosure further provides a storage medium (e.g., a computer storage medium), on which a program instruction (e.g., a computer program) is stored, and when the program instruction is executed by a computer or a processor, the corresponding steps of the face unlocking method (for example, the above-described face unlocking method 200) according to the embodiment of the present disclosure are implemented, and the corresponding modules in the face unlocking device (for example, the above-described face unlocking device 300) according to the embodiment of the present disclosure are implemented. The storage medium may include, for example, a memory card of a smart mobile phone, a storage unit of a tablet computer, a hard disk of a personal computer, a read only memory (ROM), an erasable programmable read only memory (EPROM), a portable compact disk read only memory (CD-ROM), a USB memory or any combination of the above-described storage media. The computer (readable) storage medium may be any combination of one or more computer readable storage media, and for example, one computer readable storage medium includes a computer readable program code for randomly generating an action instruction sequence, and another computer readable storage medium includes a computer readable program code for performing face unlocking. For example, the computer storage medium may be the storage device 104 illustrated in FIG. 1, and related description is not repeated herein.

In some embodiments, the computer program instruction, when executed by the computer, may implement respective functional modules of the face unlocking device according to the embodiment of the present disclosure, and/or may implement the face unlocking method according to the embodiment of the present disclosure.

In some embodiments, the computer program instruction, when executed by the computer, implements following steps: acquiring real-time image information of a user for unlocking, and generating a real-time facial image of the user for unlocking; extracting a feature based on the real-time facial image of the user for unlocking, and generating a real-time facial feature of the user for unlocking; performing search and comparison on the real-time facial feature in a face database to obtain an identity recognition result, and determining whether to perform scene recognition according to the identity recognition result; in a case where the scene recognition is performed, performing the scene recognition on the real-time image information to obtain a scene recognition result, and determining whether to unlock according to the scene recognition result; and in a case where the scene recognition is not performed, not performing unlocking.

In addition, the computer program instruction, when executed by the computer, further implements following steps.

Exemplarily, the scene recognition includes: extracting a scene image feature according to the real-time image information, and inputting a pre-trained model, to obtain the scene recognition result to indicate safety or danger.

Exemplarily, determining whether to unlock includes: in a case where the scene recognition result indicates safety, performing unlocking; and in a case where the scene recognition result indicates danger, performing alarming and/or not performing unlocking.

Exemplarily, the alarming includes: sending alarm information, in which the alarm information includes at least one of the scene recognition result, the real-time image information, or location information; or triggering an alarm bell.

Exemplarily, the scene recognition result further indicates dangerous scene information, and the dangerous scene information includes at least one of presence of a threatening appliance, an amount of threateners or attribute information of threatener.

Exemplarily, obtaining the identity recognition result includes: performing the search and comparison on the real-time facial feature in the face database, to obtain a search result; obtaining the identity recognition result according to the search result and a recognition threshold; and the search result refers to a result with a highest similarity score obtained by performing the search and comparison on the real-time facial feature in the face database.

Exemplarily, obtaining the identity recognition result according to the search result and the recognition threshold includes: in a case where a similarity score of the search result obtained by searching in the face database is less than the recognition threshold, obtaining the identity recognition result as none; and in a case where the similarity score is greater than or equal to the recognition threshold, obtaining the identity recognition result as the search result.

Exemplarily, determining whether to perform the scene recognition includes: in a case where the identity recognition result is none, not performing the scene recognition; and in a case where the identity recognition result is the search result, performing the scene recognition.

Exemplarily, after the real-time facial feature is generated, a dimension of the real-time facial feature may be reduced, and the search and comparison is performed on the real-time facial feature whose dimension is reduced in the face database.

Exemplarily, the face unlocking method further comprises: acquiring image information of all authorized users, and establishing the face database based on the image information of the authorized users.

Exemplarily, acquiring the real-time image information of the user for unlocking and generating the real-time facial image of the user for unlocking further includes: acquiring the real-time image information of the user for unlocking, determining whether or not the real-time image information comprises face information after pre-processed; and in a case where yes, generating the corresponding real-time facial image of the user for unlocking, otherwise, continuing to acquire the real-time image information of the user for unlocking.

Exemplarily, establishing the face database includes: acquiring image information of the authorized user including a face of the authorized user, pre-processing the image information of the authorized user, generating a corresponding facial image of the authorized user, extracting a feature based on the facial image of the authorized user to obtain a facial feature of the authorized user, and storing the facial feature of the authorized user in the face database.

The respective modules in the electronic device according to the embodiment of the present disclosure may be implemented when a processor executes a computer program instruction stored in a memory, or may be implemented when a computer run the computer instruction stored in the computer readable storage medium of a computer program product according to the embodiment of the present disclosure.

In the face unlocking method and device, the electronic device and the computer storage medium according to the embodiments of the present disclosure, the extracted feature of the facial image in the acquired image is recognized, and the scene recognition is performed according to the recognition result to distinguish whether the user for unlocking performs unlocking voluntarily, so as to avoid loss caused by involuntary unlocking, and an alarm may be given without being perceived, which effectively protects personal safety of the person for unlocking, and improves security of face unlocking.

Although the embodiments of the present disclosure have been described herein with reference to the drawings, it is to be understood that the embodiments are only illustrative and not intended to limit the scope of the present disclosure. Various changes and modifications may be made therein by those skilled in the art without departing from the scope and spirit of the present disclosure. All such changes and modifications shall fall within the scope of the present disclosure defined by the appended claims.

It should be appreciated by those skilled in the art that the units and the algorithm steps of the examples described in connection with the embodiments disclosed herein can be implemented in electronic hardware or a combination of computer software and electronic hardware. Whether these functions are performed in hardware or software depends on the specific application and the design constraints of the technical proposals. The described functions may be implemented by those skilled in the art in accordance with each particular application, using different methods, but such implementation should not be considered to be beyond the scope of the present disclosure.

In the several embodiments provided by the present disclosure, it should be understood that the disclosed device and method may be implemented in other manners. For example, the device embodiments described above are merely illustrative. For example, the division of the unit is only a logical function division. In actual implementation, there may be other division manners. For example, multiple units or components may be combined or integrated into another device, or some characteristics can be ignored or not executed.

In the description provided herein, numerous specific details are set forth. However, it should be understood that the embodiments of the present disclosure may be practiced without these specific details. In some examples, well-known methods, structures and technologies are not illustrated in detail so as not to obscure the understanding of the description.

Similarly, in order to simplify the present disclosure and to facilitate the understanding of one or more of the embodiments, in the description of the exemplary embodiments of the present disclosure, the characteristics of the present disclosure are sometimes grouped together into a single embodiment, figure or description thereof. However, the method provided by the present disclosure should not be construed as reflecting the following intention: the claimed disclosure requires more characteristics than those explicitly recited in each claim. More precisely, as reflected by the appended claims, the disclosure lies in that the technical problems can be solved with fewer characteristics than all of the characteristics of a single disclosed embodiment. Thus, the claims following the detailed description are hereby explicitly incorporated into the detailed description, wherein each of the claims is a separate embodiment of the present disclosure.

It should be understood by those skilled in the art that all the characteristics disclosed in the description (including the accompanying claims, abstract and drawings) and all the processes or units of all the methods or devices disclosed may be employed in any combination, unless the characteristics are mutually exclusive. Unless stated otherwise, each characteristic disclosed in the description (including the accompanying claims, abstract and drawings) may be replaced by an alternative characteristic that provides the same, equivalent or similar purpose.

In addition, it shall be understood by those skilled in the art that although some embodiments described herein include certain characteristics that are included in other embodiments and are not other characteristics, combinations of the characteristics of different embodiments are intended to be within the scope of the present disclosure and form different embodiments. For example, in the claims, any one of the claimed embodiments can be used in any combination.

The component embodiments of the present disclosure may be implemented in hardware, or in a software module running on one or more processors, or in a combination thereof. It shall be understood by those skilled in the art that a microprocessor or a DSP may be used in practice to implement some or all of the functions of some modules in the unlocking device provided by the embodiment of the present disclosure. The present disclosure may also be implemented as a device program (e.g., a computer program and a computer program product) for executing some or all of the methods described herein. The programs of the present disclosure may be stored on a computer readable medium or may be in the form of one or more signals. Such signals can be downloaded from the internet website, provided on carrier signals, or provided in any other form.

It should be noted that the above embodiments are illustrative of the present disclosure and are not intended to limit the present disclosure, and alternative embodiments can be designed by those skilled in the art without departing from the scope of the appended claims. In the claims, any reference mark placed between parentheses shall not be construed as a limitation of the claims. The word “comprise” does not exclude the presence of elements or steps that are not recited in the claims. The word “a” or “an” disposed before the element does not exclude the existence of multiple such elements. The present disclosure can be implemented by hardware comprising several different elements, and by a suitably programmed computer. In the unit claims enumerating several units, some of these units can be embodied by the same hardware item. The use of the words first, second, third and the like does not indicate any order. These words can be interpreted as names.

What have been described above are only specific implementations of the present disclosure, the protection scope of the present disclosure is not limited thereto, and any changes or substitutions that are obvious to those skilled in the art within the scope of the present disclosure are intended to be included within the scope of the present disclosure. The protection scope of the present disclosure should be based on the protection scope of the claims.

What is claimed is:

1. A face unlocking method, comprising:
acquiring real-time image information of a user for unlocking, and generating a real-time facial image of the user for unlocking;
extracting a feature based on the real-time facial image of the user for unlocking, and generating a real-time facial feature of the user for unlocking;
performing search and comparison on the real-time facial feature in a face database to obtain an identity recognition result, and determining whether to perform scene recognition according to the identity recognition result;
in a case where the scene recognition is performed, performing the scene recognition on the real-time image information to obtain a scene recognition result, and determining whether to unlock according to the scene recognition result; and
in a case where the scene recognition is not performed, not performing unlocking.

2. The face unlocking method according to claim 1, wherein performing the scene recognition comprises:
extracting a scene image feature according to the real-time image information, and inputting a pre-trained model to obtain the scene recognition result to indicate safety or danger.

3. The face unlocking method according to claim 2, wherein determining whether to unlock comprises:
in a case where the scene recognition result indicates safety, performing unlocking; and
in a case where the scene recognition result indicates danger, performing at least one of alarming or not performing unlocking.

4. The face unlocking method according to claim 3, wherein the alarming comprises:
sending alarm information, wherein the alarm information comprises at least one of the scene recognition result, the real-time image information, or location information; or triggering an alarm bell.

5. The face unlocking method according to claim 1, wherein the scene recognition result further indicates dangerous scene information, and the dangerous scene information comprises at least one of presence of a threatening appliance, an amount of threateners, or attribute information of threateners.

6. The face unlocking method according to claim 1, wherein obtaining the identity recognition result comprises:
performing the search and comparison on the real-time facial feature in the face database, to obtain a search result; and
obtaining the identity recognition result according to the search result and a recognition threshold;
wherein the search result refers to a result with a highest similarity score obtained by performing the search and comparison on the real-time facial feature in the face database.

7. The face unlocking method according to claim 6, wherein obtaining the identity recognition result according to the search result and the recognition threshold comprises:
in a case where a similarity score of the search result obtained by performing the search and comparison in the face database is less than the recognition threshold, obtaining the identity recognition result as none; and
in a case where the similarity score of the search result obtained by performing the search and comparison in the face database is greater than or equal to the recognition threshold, obtaining the identity recognition result as the search result.

8. The face unlocking method according to claim 7, wherein determining whether to perform the scene recognition comprises:
in a case where the identity recognition result is none, not performing the scene recognition; and
in a case where the identity recognition result is the search result, performing the scene recognition.

9. The face unlocking method according to claim 1, wherein after the real-time facial feature is generated, a dimension of the real-time facial feature is reduced, and the search and comparison is performed on the real-time facial feature whose dimension is reduced in the face database.

10. The face unlocking method according to claim 1, further comprising:
acquiring image information of all authorized users; and
establishing the face database based on the image information of the authorized users.

11. The face unlocking method according to claim 1, wherein acquiring the real-time image information of the user for unlocking and generating the real-time facial image of the user for unlocking further comprises:
acquiring the real-time image information of the user for unlocking;
determining whether the real-time image information comprises facial information after pre-processing; and
in a case where the real-time image information comprises the facial information after pre-processing, generating the corresponding real-time facial image of the user for unlocking, and in a case where the real-time image information does not comprise the facial information after pre-processing, continuing to acquire the real-time image information of the user for unlocking.

12. The face unlocking method according to claim 10, wherein establishing the face database comprises:
acquiring the image information of the authorized users comprising faces of the authorized users;
pre-processing the image information of the authorized users to generate corresponding facial images of the authorized users;
extracting features based on the facial images of the authorized users to obtain facial features of the authorized users; and
storing the facial features of the authorized users in the face database.

13. A face unlocking device, comprising:
an image acquisition module, configured to acquire image information of an authorized user or real-time image information of a user for unlocking, and perform a face detection on the image information of the authorized user or the real-time image information of the user for unlocking, to generate a facial image of the authorized user or a real-time facial image of the user for unlocking;
a facial feature extraction module, configured to extract a facial feature based on the facial image of the authorized user or the real-time facial image of the user for unlocking, to obtain a facial image feature of the authorized user or a real-time facial feature of the user for unlocking;
a storage medium module, configured to store the facial image feature of the authorized user in a face database;
a face comparison module, configured to perform search and comparison on the real-time facial feature in the face database to obtain an identity recognition result, and determine whether to perform scene recognition according to the identity recognition result;
a scene recognition module, configured to recognize a scene in the real-time image information to obtain a scene recognition result; and
a physical lock control module, configured to control a lock state of a physical device according to the identity recognition result or the scene recognition result.

14. The face unlocking device according to claim 13, further comprising: an alarm module, configured to perform alarming according to the scene recognition result;
wherein the alarming comprises sending alarm information or triggering an alarm bell, and the alarm information comprises at least one of the scene recognition result, the real-time image information or location information.

15. The face unlocking device according to claim 13, wherein the image acquisition module comprises:
an image information receiving module, configured to receive the image information of the authorized user or the real-time image information of the user for unlocking;
a framing module, configured to perform video image framing on video data in the image information of the authorized user or the real-time image information of the user for unlocking;
a face detection module, configured to perform a face detection and tracking on a single-frame image output by the image information receiving module or each frame of multi-frame images output by the framing module, and generate the facial image of the authorized user or the real-time facial image of the user for unlocking; and
an obtaining determination module, configured to determine whether the real-time image information of the user for unlocking comprises facial information, and in a case where the real-time image information of the user for unlocking comprises facial information, the face detection module generates the corresponding real-time facial image of the user for unlocking, and where the real-time image information of the user for unlocking does not comprise facial information, continue to acquire the real-time image information of the user for unlocking.

16. The face unlocking device according to claim 13, wherein the facial feature extraction module comprises:
a facial feature dimension reduction module, configured to reduce a dimension of the real-time facial feature of the user for unlocking after the real-time facial feature of the user for unlocking is generated.

17. The face unlocking device according to claim 13, wherein the storage medium module is further configured to store the facial image of the authorized user in the face database.

18. The face unlocking device according to claim 13, wherein the face comparison module comprises:
a face search module, configured to perform the search and comparison on the real-time facial feature of the user for unlocking in the face database, to obtain a search result, wherein the search result refers to a result with a highest similarity score obtained by performing the search and comparison on the real-time facial feature in the face database;
an identity recognition module, configured to obtain the identity recognition result according to the search result and a recognition threshold; and
a scene recognition determination module, configured to determine whether to perform the scene recognition according to the identity recognition result.

19. An electronic device, comprising a memory, a processor, and a computer program stored on the memory and executed by the processor, wherein the processor executes the computer program to implement the face unlocking method according to claim 1.

20. A computer storage medium, storing with a computer program, wherein the computer program is executed by a computer to implement the face unlocking method according to claim 1.
